(19) United States
(12) Patent Application Publication
(10) Pub. No.: US 2010/0154981 A1
(43) Pub. Date: Jun. 24, 2010

(54) SWITCH SHEET

(75) Inventor: Toshimizu TOMITSUKA, Bangkok (TH)

Correspondence Address: SUGHRUE MION, PLLC, 2100 PENNSYLVANIA AVENUE, N.W., SUITE 800, WASHINGTON, DC, 20037, US

(73) Assignee: FUJIKURA LTD., Tokyo (JP)

(21) Appl. No.: 12/718,307

(22) Filed: Mar. 5, 2010

Related U.S. Application Data
(62) Division of application No. 11/962,629, filed on Dec. 21, 2007, now abandoned.

(30) Foreign Application Priority Data
Dec. 26, 2006 (JP) 2006-350436

(51) Int. Cl. B32B 37/02

(52) U.S. Cl. 156/196

(57) ABSTRACT

A switch sheet is used in combination with a substrate having a first contact and a second contact. The switch sheet is comprised of an elastically deformable dome of a conductive material; and a sheet covering the dome and including an embossment projecting from a top of the dome. The sheet is so dimensioned as to have the dome suspended over the first contact and in contact with the second contact.

### CROSS-REFERENCE TO RELATED APPLICATIONS

This application is a divisional application of U.S. application Ser. No. 11/962,629 filed Dec. 21, 2007 which claims priority based on Japanese Patent Application No. 2006-350436 filed Dec. 26, 2006. The entire disclosures of the prior applications are hereby incorporated by reference.

### BACKGROUND OF THE INVENTION

1. Field of the Invention

Apparatuses consistent with the present invention relate to switch sheets applied to electronic devices, in particular compact electronic devices such as mobile phones.

2. Description of the Related Art

Compact electronic devices such as mobile phones, digital cameras, PDAs, MD or CD players and such are in general equipped with a keypad including a plurality of switches for command input, in which the switches are arrange in a row or a matrix. The keypad is often made in a sheet-like shape in pursuit of compactness. A sheet-like keypad is typically comprised of a substrate with conductive contacts printed thereon, and dome-like key tops respectively covering the contacts. When an operator presses down one of the key tops, the key top deforms to be in contact with the corresponding contact, and thereby conduction is established (the switch is switched ON).

A dome-like key top offers the following advantage. FIG. 1 illustrates a typical load-displacement curve about such a dome-like key top. When an operator is pressing down the key top as far as a load thereon is still under a threshold of P1, displacement thereof increases as the load increases but is not sufficient to have the contacts get in contact. More specifically, the key function as an elastic body against the load. However, if the load reaches the threshold of P1, the displacement keeps increasing but the load required for the displacement starts decreasing. Finally the displacement reaches S3 and then the contacts get in contact (the switch is ON). This profile of the load-displacement curve gives a click feel to the operator and thereby the operator can ascertain if the switch is ON.

### SUMMARY OF THE INVENTION

Certain embodiments of the present invention provide a switch sheet providing a better click feel and having improved durability.

According to an exemplary embodiment of the present invention, a switch sheet is used in combination with a substrate having a first contact and a second contact. The switch sheet is comprised of an elastically deformable dome including a conductive material; and a sheet covering the dome and including an embossment projecting from a top of the dome, the sheet being so dimensioned as to have the dome suspended over the first contact and in contact with the second contact.

Preferably, the embossment is produced by embossing. Still preferably, the switch sheet is further comprised of an intervening member intervening between the dome and the sheet so as to have the embossment projecting. More preferably, the intervening member is made of a material selected from the group of silicon rubber, metals and polyester resins.

### BRIEF DESCRIPTION OF THE DRAWINGS

FIG. 1 is an exemplary graph of a load-displacement curve about a switch sheet having a dome-like key top;

FIG. 2A is a partial sectional view of a switch sheet according to an exemplary embodiment of the present invention, and FIG. 2B is that at a time of being pressed down;

FIG. 3 is a sectional view of the switch sheet, in which three switches are in view;

FIG. 4 is a broken perspective view of the switch sheet under production;

FIGS. 5A and 5B respectively show comparative and working examples served for experiments;

FIG. 6A is a graph showing a relation between maximum and minimum loads and offset values about the comparative example with an actuator of 1 mmΦ, and FIG. 6B is a graph showing click ratios calculated therefrom;

FIG. 7A is a graph showing a relation between maximum and minimum loads and offset values about the working example with an actuator of 1 mmΦ, and FIG. 7B is a graph showing click ratios calculated therefrom;

FIG. 8A is a graph showing a relation between maximum and minimum loads and offset values about the comparative example with an actuator of 1.5 mmΦ, and FIG. 8B is a graph showing click ratios calculated therefrom;

FIG. 9A is a graph showing a relation between maximum and minimum loads and offset values about the working example with an actuator of 1.5 mmΦ, and FIG. 9B is a graph showing click ratios calculated therefrom;

FIG. 10A is a graph showing a relation between maximum and minimum loads and offset values about the comparative example with an actuator of 2 mmΦ, and FIG. 10B is a graph showing click ratios calculated therefrom;

FIG. 11A is a graph showing a relation between maximum and minimum loads and offset values about the working example with an actuator of 2 mmΦ, and FIG. 11B is a graph showing click ratios calculated therefrom;

FIG. 12A is a graph showing a relation between maximum and minimum loads and offset values about the comparative example with an actuator of 2.6 mmΦ, and FIG. 12B is a graph showing click ratios calculated therefrom;

FIG. 13A is a graph showing a relation between maximum and minimum loads and offset values about the working example with an actuator of 2.6 mmΦ, and FIG. 13B is a graph showing click ratios calculated therefrom;

FIG. 14 is a graph showing stable ranges where click ratios are 40% or greater; and

FIG. 15 is a graph which compares click ratios of the working example and the comparative example.

### DETAILED DESCRIPTION OF THE EXEMPLARY EMBODIMENTS

Exemplary embodiments of the present invention will be described hereinafter with reference to the appended drawings.

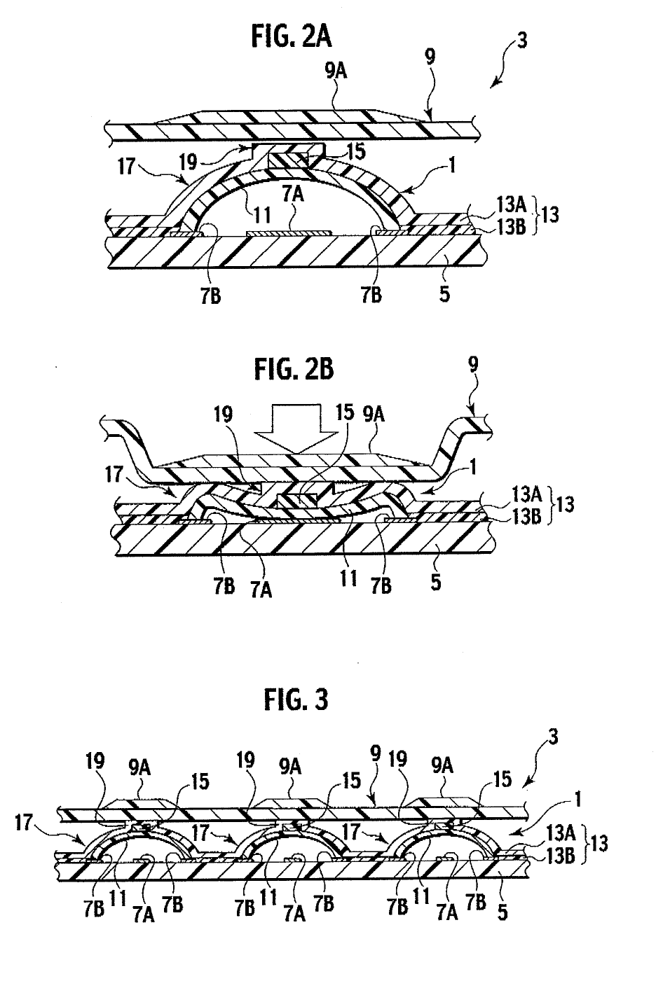

Referring to FIGS. 2A, 2B and 3, a switch sheet 1 of the embodiment is applied to a keypad 3 for operation of compact electronic devices such as mobile phones, digital cameras, PDAs, MD or CD players and such. The keypad 3 is comprised of one or more switch keys forming a row or a matrix as shown in FIG. 3.

The keypad 3 is comprised of a substrate 5 made of a PCB (Printed Circuit Board) or a FPC (Flexible Printed Circuit) and one or more contacts 7A made of any conductive material formed thereon. One or more circular contacts 7B respectively enclosing the contacts 7A are further formed on the substrate 5. The contacts 7A are respectively disposed at centers of the circular contacts 7B. Production of these contacts 7A and 7B may be carried out by, but not limited to, a well-known printing or plating method.

The keypad 3 is further comprised of the switch sheet 1 and a key mat 9 for covering the switch sheet 1. The key mat 9 is so disposed as to be opposed to and close to the switch sheet 1 for enabling actuation of the switch sheet 1 by a press of the key mat 9. The key mat 9 may be made of, but not limited to, a silicon rubber. The key mat 9 may have pads 9A unitarily projecting therefrom or adhered thereon for the purpose of reinforcement thereof and indication of keys.

The switch sheet 1 is used in combination with the substrate 5 and the key mat 9 as described above. The switch sheet 1 is comprised of elastically deformable domes 11 made of a conductive material. The domes 11 are formed in a dome-like or semi-spherical shape. Whereas its shape is not limited to the dome-like shape, this shape may be preferable for elastic deformation by a press and providing a click feel.

The domes 11 may be produced by, though not limited to, punching, presswork or forging from a sheet of a proper elastic conductive material such as stainless steels, copper, aluminum or these alloys. The outer diameter of the domes 11 is made corresponding to the circular contacts 7B.

The switch sheet 1 is further comprised of a covering sheet 13 made of any resin for example, which closely covers the domes 11. The covering sheet 13 follows curved surfaces of the domes 11 and carries out positioning of the domes 11 so as to have the domes 11 respectively suspended over the contacts 7A and in contact with the circular contacts 7B. The covering sheet 13 is comprised of a sheet 13A and an adhesive agent 13B on its surface opposed to the substrate 5 so that the covering sheet 13 adheres to the substrate 5.

As the domes 11 are put in regular positions with respect to contacts 7A and 7B by the switch sheet 1, tops of the domes 11 and the contacts 7A are respectively aligned as shown in FIG. 3. Therefore, when any of the tops of the domes 11 is pressed down, the top comes in contact with the corresponding contact 7A to establish conduction among the contact 7B, the dome 11 and the contact 7A as shown in FIG. 2B.

Intervening between the covering sheet 13 and the domes 11, intervening members 15 are disposed on the respective tops of the domes 11. Corresponding cites of the covering sheet 13 has embossments 19 respectively projecting upward from the tops of the domes 11. The intervening members 15 are formed into, but not limited to, a low columnar or cuboid shape to have a plane top face. It is advantageous to improvement in quality of symmetry of deformation around the center of the dome 11 at a time of being pressed down, even if the pressure force is inclined or has an offset from the center.

The height of the intervening member 15, which may be corresponding to the height of the embossment 19, is preferably from ⅓ to ⅔ of a stroke of (or the height of) the dome 11 from a steady state to a state where the dome 11 is in contact with the contact 7A. For example, if the dome 11 has a stroke of 0.16 mm, the height of the intervening member 15 is preferably from 0.05 mm to 1.0 mm. The reason is that heights greater than 0.05 mm help an operator press the dome 11 and heights smaller than 1.0 mm effectively prevent the embossment 19 from receiving inclined or shearing force. In particular, prevention of inclined or shearing force leads to improvement of durability.

The diameter of the intervening member 15 is preferably from ¼ to ¾ of the diameter of the dome 11. For example, if the dome 11 has a diameter of 4 mm, the diameter of the intervening member 15 is preferably from 1.0 mm to 3.0 mm. The reason is that diameters greater than 1.0 mm help an operator press the dome 11 and diameters smaller than 3.0 mm do not force a rim portion of the dome 11 to excessively deform. In particular, prevention of excessive deformation leads to improvement of durability.

The intervening members 15 may be made from silicon rubber, metals or polyester resins. These materials are preferable for operability of the switch sheet 1 as being not softer than the key mat 9.

The sheet 13A of the covering sheet 13 is formed of a polyethylene or polyester sheet having a thickness of from 25 μm to 75 μm, for example. The adhesive agent 13B is formed of an adhesive or sticking agent of an acrylic series or silicon series, for example. The adhesive agent 13B may be provided only on surfaces opposed to the substrate 5 but may be provided also on surfaces opposed to the domes 11.

The covering sheet 13 may be treated with embossing so as to have a structure fitting with the domes 11. Moreover, the embossments 19 may be also produced by embossing. The intervening members 15 are respectively fit into the interiors of the embossments 19.

The switch sheet 1 may further have biasing means such as springs (not shown) for biasing the key mat 9 in a direction departing from the substrate 5 (upward in FIG. 2A).

As the switch sheet 1 is structured in the way as described above, when an operator presses his/her finger onto one of the pads 9A of the key mat 9, the corresponding embossment 19 is pressed down by the descending key mat 9 and thereby the top of the corresponding dome 11 starts deforming downward as shown in FIG. 2B. The top and its periphery elastically deform to cave in as if these portions turn over, and thereby the dome 11 gets in contact with the contact 7A to establish conduction therebetween. Then the switch key is switched ON. The switch sheet 1 also provides the operator a click feel. A detailed description about the click feel will be given later.

A production method of the switch sheet 1 will be exemplarily described hereinafter.

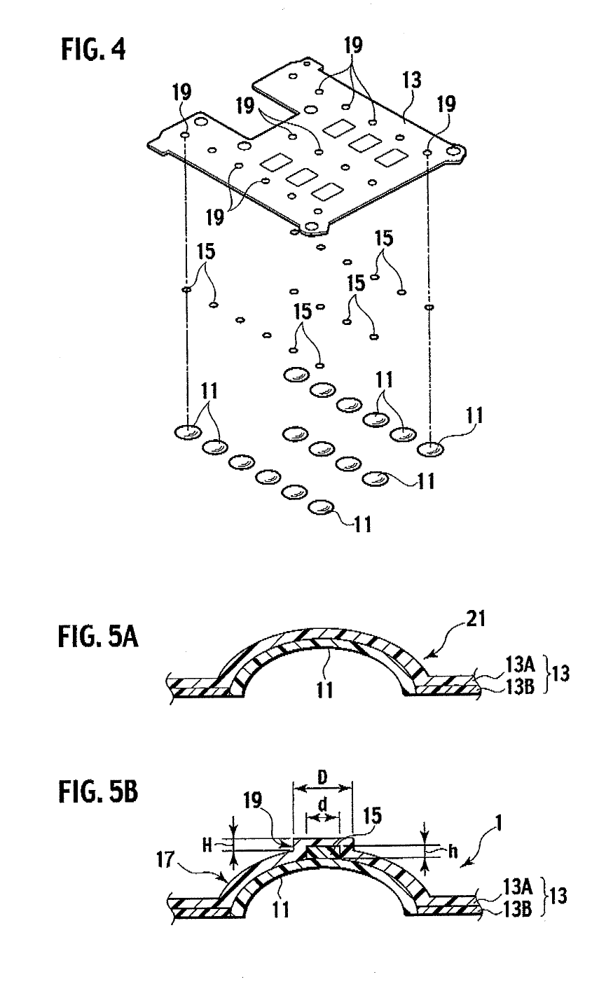

Referring to FIG. 4, the sheet 13A of any of polyester resins such as PET having a thickness of from 25 μm to 75 μm coated with the adhesive agent 13B is treated with embossing to form dome-like embossments which respectively fit with the domes 11 and the embossments 19 respectively at the centers thereof. The embossing is carried out using embossing dies respectively having male and female shapes of the embossments.

The intervening members 15 are produced by punching a film of a polyester resin such as PET having a thickness of 125 mm, for example.

The domes 11 are produced by presswork from a sheet of a stainless steel or a phosphor bronze to form a semispherical shape.

The covering sheet 13, the intervening members 15 and the domes 11 are aligned using proper jigs (not shown) as shown in FIG. 4 and then adhered with each other. Thereby the switch sheet 1 is produced.

Experiments for the purpose of demonstrating advantages provided by the present invention were executed. A switch sheet as a working example, which is made in line with the aforementioned embodiment, and a switch sheet 21 as a comparative example having a structure described later were served for the experiments.

FIG. 5A illustrates a structure of the switch sheet 21 of the comparative example. The switch sheet 21 is comprised of an elastically deformable dome 11, a covering sheet 13A, and an adhesive agent 13B as identical to the switch sheet 1 of the working example, but an intervening member 15 and an embossment 19 are omitted from the switch sheet 21.

FIG. 5B illustrates a structure of the switch sheet 1 of the working example, which is comprised of an elastically deformable dome 11, a covering sheet 13A, an adhesive agent 13B, an intervening member 15 disposed at the top of the dome 11, and an embossment 19 projecting therefrom. The height h of the intervening member 15 is 0.125 mm and the diameter d is 1.5 mm for example. The height H of the embossment 19 is 0.126 mm and the diameter D is 2.3 mm for example.

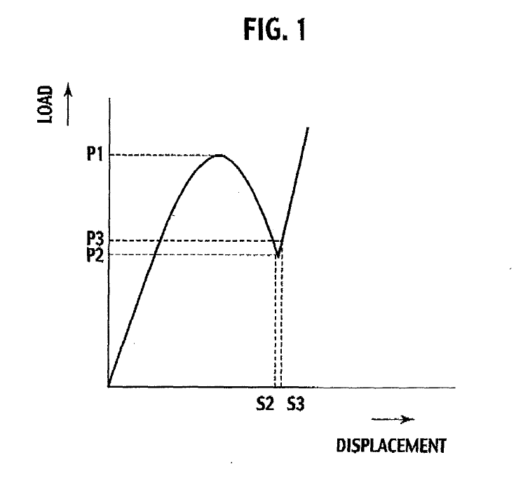

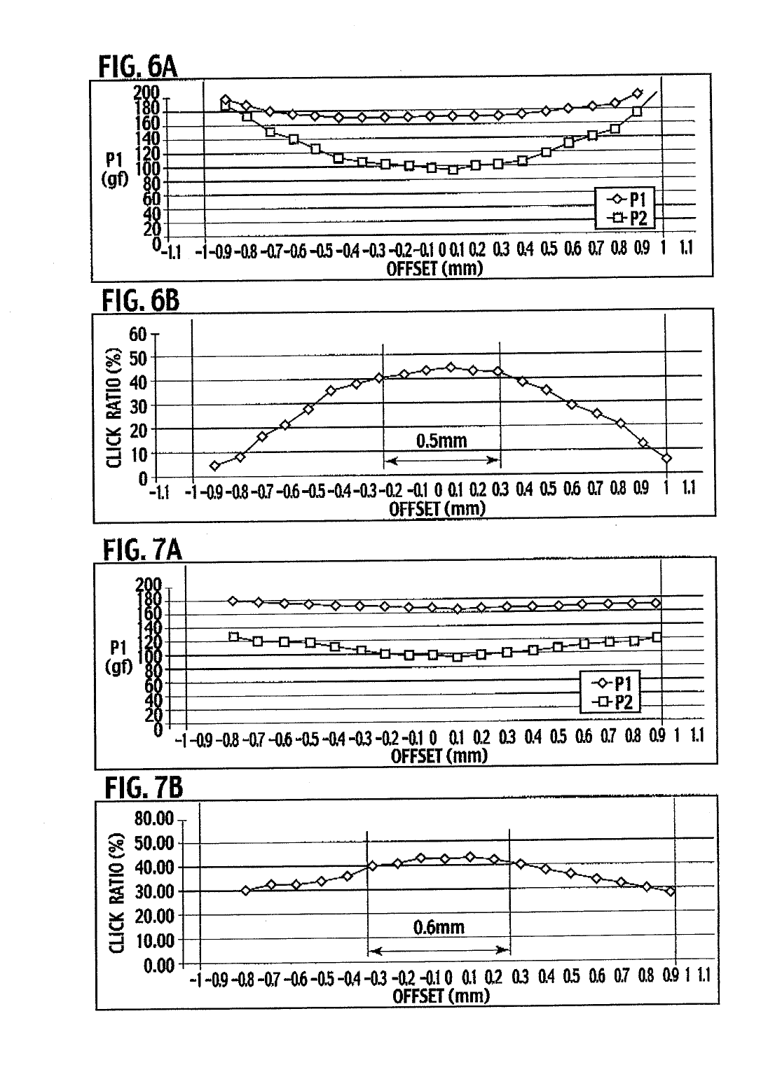

The switch sheets 1, 21 were pressed down by various actuators having diameters of 1.0 mmΦ, 1.5 mmΦ, 2.0 mmΦ and 2.6 mmΦ, and respective loads were measured at various points having offsets from the center of the dome 11. As the measured load profiles showed features like as the load-displacement curve shown in FIG. 1, maximum loads P1 and the minimum loads P2 were respectively measured and plotted in FIGS. 6A-13A as in relation to the offsets. Further, click ratios are calculated on the basis of an equation of Click Ratio (%)=(P1−P2)/P1 and plotted in FIGS. 6B-13B as in relation to the offsets.

Quality of a click feel can be evaluated on the basis of the maximum load P1, the click ratio and a stroke S2. The maximum load P1 relates to a force required for operation of the switch. The greater the click ratio is, the better a click feel which an operator enjoys becomes, thereby the operator easily ascertains if the switch is ON. The same applies to the stroke S2.

Throughout the obtained graphs, the curves of the minimum loads P2 show more noticeable tendency of having minimums around the points where the offset is zero or near zero, as compared with those of the maximum loads P1. The click ratios calculated from P1 and P2 resultantly have maximums around the points where the offset is zero or near zero. For the sake of convenience, a range of the offsets where the click ratios are greater than 40% will be referred to as a “stable range” hereinafter, where a click feel may be sufficiently good.

FIGS. 6A and 6B show results about the switch sheet 21 of the comparative example (without an embossment) pressed by the actuator having the diameter of 1.0 mmΦ. A stable range where the click ratios are greater than 40% is 0.5 mm. In contrast, FIGS. 7A and 7B show results about the switch sheet 1 of the working example (with an embossment) pressed by the same actuator having the diameter of 1.0 mmΦ. A stable range of the working example is 0.6 mm.

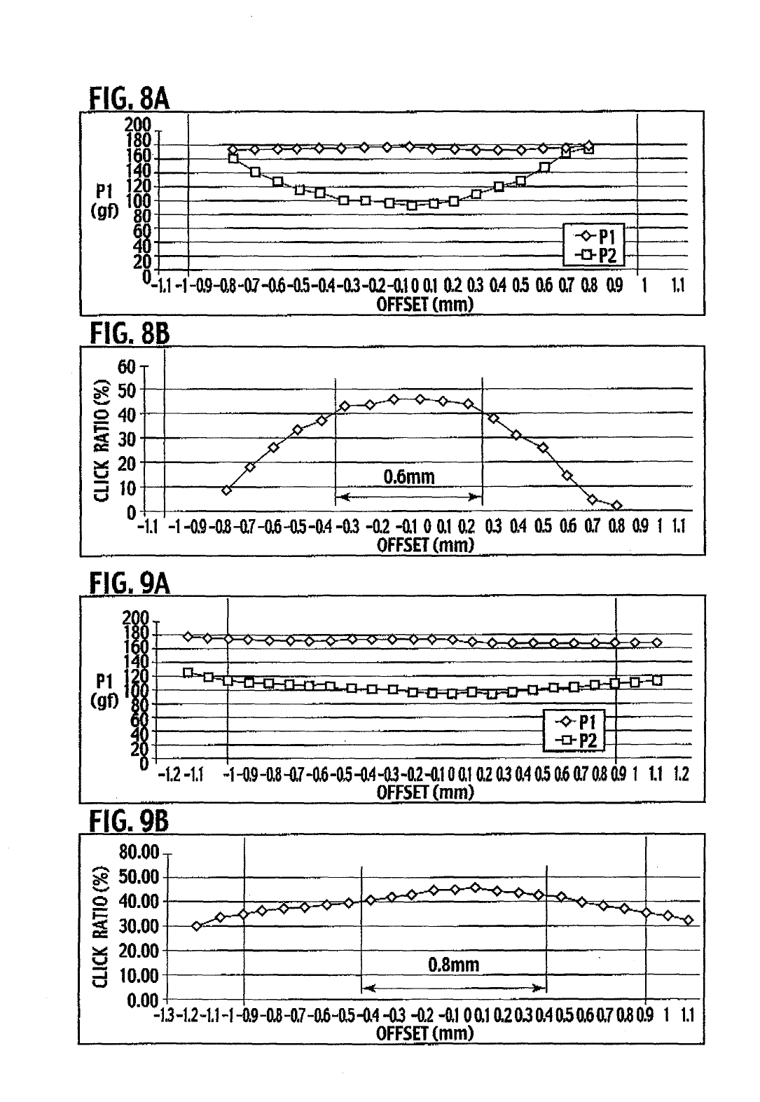

FIGS. 8A and 8B show results about the switch sheet 21 of the comparative example pressed by the actuator having the diameter of 1.5 mmΦ. A stable range of the comparative example is 0.6 mm. In contrast, FIGS. 9A and 9B show results about the switch sheet 1 of the working example pressed by the same actuator having the diameter of 1.5 mmΦ. A stable range of the working example is 0.8 mm.

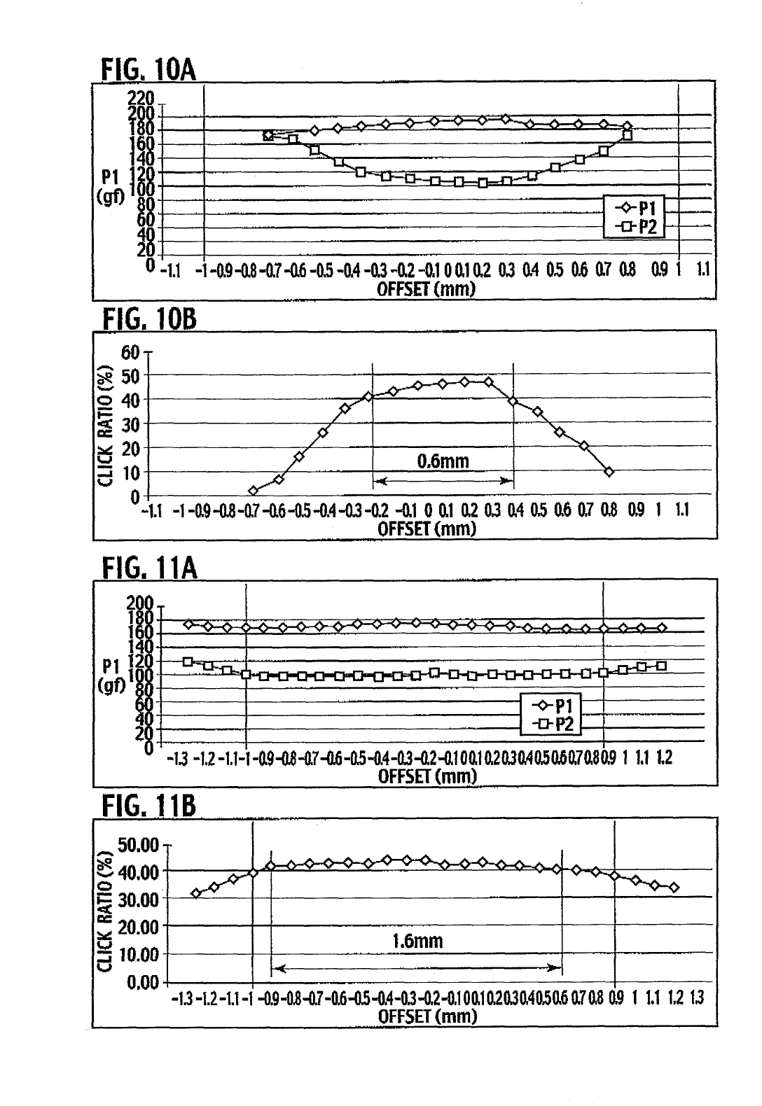

FIGS. 10A and 10B show results about the switch sheet 21 of the comparative example pressed by the actuator having the diameter of 2.0 mmΦ. A stable range of the comparative example is 0.6 mm. In contrast, FIGS. 11A and 11B show results about the switch sheet 1 of the working example pressed by the same actuator having the diameter of 2.0 mmΦ. A stable range of the working example is 1.6 mm.

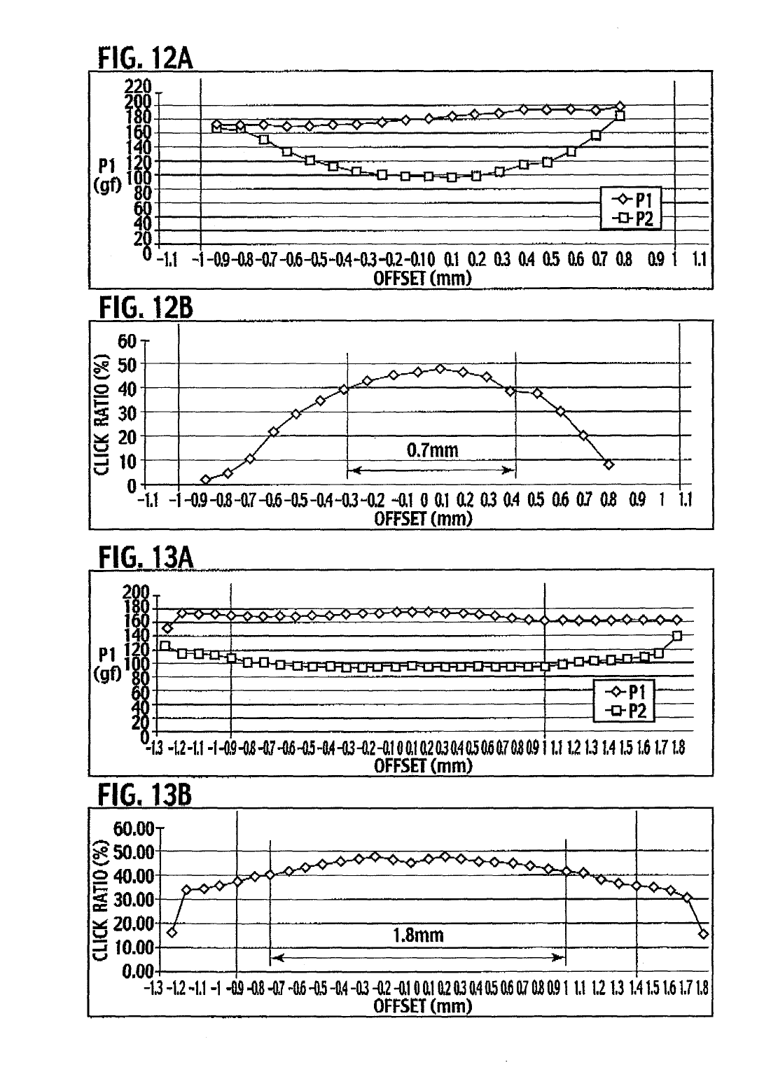

FIGS. 12A and 12B show results about the switch sheet 21 of the comparative example pressed by the actuator having the diameter of 2.6 mmΦ. A stable range of the comparative example is 0.7 mm. In contrast, FIGS. 13A and 13B show results about the switch sheet 1 of the working example pressed by the same actuator having the diameter of 2.6 mmΦ. A stable range of the working example is 1.8 mm.

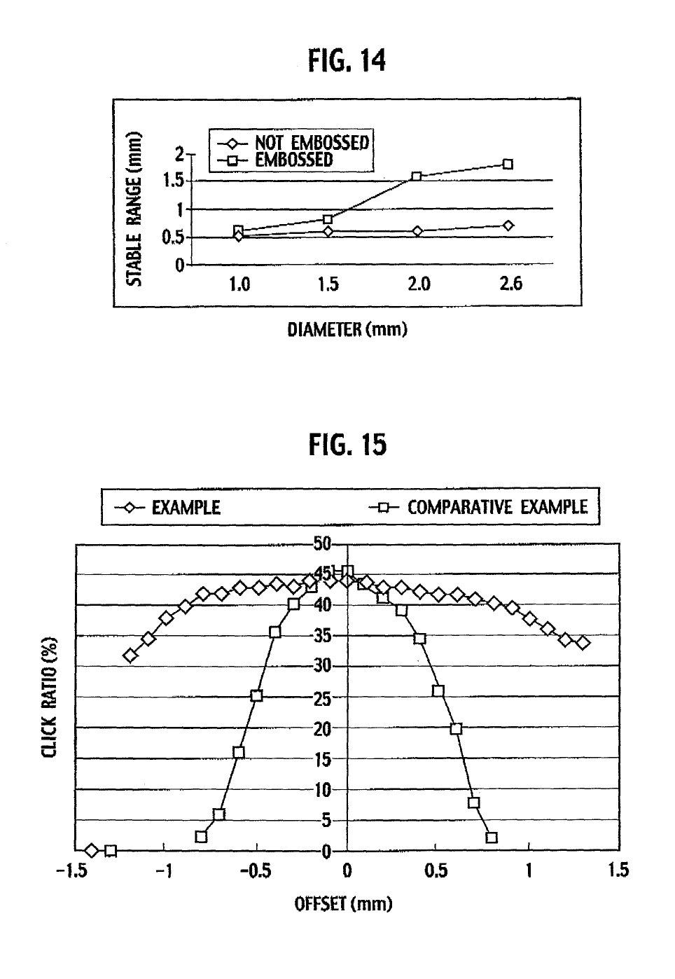

The stable ranges obtained in the aforementioned experiments are summarized in Table 1 and FIG. 14.

TABLE 1

| | Stable ranges where click ratios | |
|---|---|---|
| | are greater than 40% (mm) | |
| Diameters of actuators | Comparative example | Working example |
| (mm) | (without an embossment) | (with an embossment) |
| 1.0 | 0.5 | 0.6 |
| 1.5 | 0.6 | 0.8 |
| 2.0 | 0.6 | 1.6 |
| 2.6 | 0.7 | 1.8 |

The P2 curves of the switch sheet 1 in the graphs show gentler slopes than those of the switch sheet 21. As a result, the switch sheet 1 of the working example (with an embossment) has broader stable ranges than the switch sheet 21 of the comparative example (without an embossment). The experimental results demonstrate the following advantages of the switch sheet 1 as compared with the switch sheet 21.

When an operator presses down a switch, a spot to be pressed may be generally deviated from the center of the switch because any human being cannot act with machinelike precision. However, as the switch sheet 1 has a broader stable range as compared with the comparative example, the switch sheet 1 may give a greater probability that the spot to be pressed comes within the stable range. Then the operator can enjoy a sufficient click feel so as to ascertain if the switch is ON.

Moreover, the broader stable range is advantageous in view of improvement of durability of the switch sheet 1. A dome of a switch sheet will fracture with a certain possibility if the switch sheet is subject to a great number of operations. The possibility depends on an offset of a spot to be pressed because deformation of the dome becomes less uniform or symmetric when the offset is greater. Table 2 shows numbers of fractured samples among 6024 samples tested in durability tests in which the samples are subject to one million operations.

TABLE 2

| Offset | 0 mm | 0.3 mm | 0.5 mm | 0.7 mm |
|---|---|---|---|---|
| Numbers of | 8 | 14 | 14 | 31 |
| fractured | | | | |
| samples | | | | |

(among 6024 tested samples)

As being understood from the above test results, probabilities of fracture are not prominently changed as long as the offsets are smaller than 0.7 mm (within the stable range). However, the samples reciprocally pressed at a spot having an offset of 0.7 mm (corresponding to the edge of the stable range) become prominently susceptible to fracture. In contrast, as the switch sheet 1 in accordance with the embodiment of the present invention has the broader stable range, a spot even having a relatively large offset may come within the stable range. The switch sheet 1 may be insusceptible to greater probability of fracture and is therefore expected to have improved durability.

The broader stable range also leads to enabling easing tolerance of size and positioning. A switch sheet is usually covered with a key mat which provides a target to be pressed. As the stable range is made broader in the switch sheet 1, tolerance of positioning between the switch sheet 1 and the key mat 9 may be considerably eased. Moderation intolerance is advantageous in view of ease of production.

Although the invention has been described above by reference to certain exemplary embodiments of the invention, the invention is not limited to the exemplary embodiments described above. Modifications and variations of the embodiments described above will occur to those skilled in the art, in light of the above teachings.

What is claimed is:

1. A method for manufacturing a switch sheet for use in combination with a substrate having a first contact and a second contact, the method comprising:
producing an elastically deformable dome including a conductive material, the dome being so dimensioned as to be suspended over the first contact and in contact with the second contact;
embossing a sheet with an embossment; and
adhering an intervening member and the dome to the sheet so as to have the intervening member fit into the interior of the embossment, whereby the embossment along with the intervening member projects from a top of the dome.

2. The method of claim 1 further comprising:
forming the intervening member into a shape having a plane top face.

3. The method of claim 1 further comprising:
closely covering the dome with the sheet along with the intervening member.
